(19) United States
(12) Patent Application Publication
(10) Pub. No.: US 2026/0336945 A1
(43) Pub. Date: Oct. 29, 2026

(54) METHOD FOR MONITORING A PRODUCT FLOW

(71) Applicant: ETO GRUPPE TECHNOLOGIES GMBH, Stockach (DE)

(72) Inventors: Walter NAUMANN, Immenstaad (DE); Lutz DITTRICH, Immenstaad (DE); Benjamin BÖNISCH, Bodman-Ludwigshafen (DE)

(21) Appl. No.: 19/099,223

(22) PCT Filed: Jul. 26, 2023
(86) PCT No.: PCT/EP2023/070690

§ 371 Date: Jan. 28, 2025

(30) Foreign Application Priority Data
Jul. 29, 2022 (DE) 10 2022 119 131.1

(51) Int. Cl. B65G 43/08; B65G 67/24

(52) U.S. Cl. CPC B65G 43/08; B65G 67/24; B65G 2203/0216; B65G 2203/0283; B65G 2203/044; B65G 2203/046

(57) ABSTRACT

A method for monitoring product flows comprises the following steps:

detecting when a product is picked up by the conveyor device by reading out a product tag,

monitoring the loading state of the product by repeated or continuous reading of the product tag,

detecting when the conveyor device enters a loading zone of the product receiving unit by capturing when a geofence region delimiting the loading zone is transcended by means of a conveyor device tag assigned to the conveyor device and/or by means of a product receiving unit tag assigned to the product receiving unit,

detecting when the product is deposited no longer being able to read the product tag, and

detecting when the conveyor device no longer transporting the product leaves the loading zone by capturing when the geofence region is transcended by means of the conveyor device tag and/or by means of the product receiving unit tag.

### CROSS-REFERENCE TO RELATED APPLICATIONS

This patent application is a U.S. national stage application of international patent application PCT/EP 2023/070690, filed on Jul. 26, 2023, which is based on and claims priority to German patent application DE 10 2022 119 131.1, filed on Jul. 29, 2022, the contents which are incorporated herein by reference.

### PRIOR ART

The invention relates to a method, to an apparatus and to a system.

A method for monitoring product flows with at least one product receiving unit, which provides a storage space for a temporary accommodation of products, and with at least one conveyor device, which is movable at least within the warehouse and is configured for transporting products at least within the warehouse and/or carrying out a process of loading products into the product receiving unit and/or a process of unloading products from the product receiving unit, has already been proposed. The known methods for monitoring product flows in warehouses, however, require manual interventions by operating personnel at multiple points, e.g. for reading out barcodes for identifying a currently moving product or for manually confirming that a certain product has been unloaded or picked up by the operating personnel.

The object of the invention is in particular to provide a method having advantageous properties with regard to monitoring loading and/or unloading processes, in particular in warehouses. The object is achieved according to the invention.

### ADVANTAGES OF THE INVENTION

The invention is based on a method for monitoring product flows, in particular at least within a warehouse, with at least one product receiving unit, which provides a storage space for a temporary accommodation of products, and with at least one conveyor device, in particular a floor conveyor device, which is movable at least within the warehouse and is configured for transporting products at least within the warehouse and/or carrying out a process of loading products into the product receiving unit and/or a process of unloading products from the product receiving unit.

It is proposed that at least the following steps are carried out in order to detect a completed loading process:
detecting when a product is picked up by the conveyor device by reading out a product tag assigned to the product by means of a reader assigned to the conveyor device,
monitoring the loading state of the product on the conveyor device by repeated or continuous reading out of the product tag assigned to the product by means of the reader assigned to the conveyor device,
detecting when the conveyor device transporting the product enters a loading zone of the product receiving unit by capturing when a geofence region delimiting the loading zone is transcended, in particular within the geofence region, by means of a conveyor device tag assigned to the conveyor device and/or by means of a product receiving unit tag assigned to the product receiving unit,
detecting when the product is deposited by the conveyor device by virtue of no longer being able to read out the product tag assigned to the product by means of the reader assigned to the conveyor device and
detecting when the conveyor device no longer transporting the product leaves the loading zone by capturing when the geofence region delimiting the loading zone is transcended, in particular to outside the geofence region, by means of the conveyor device tag assigned to the conveyor device and/or by means of the product receiving unit tag assigned to the product receiving unit.

As a result, monitoring of product flows can be advantageously improved, in particular made more reliable and/or safer, in particular by being able to reliably detect when a product, in particular an identified product, is loaded. The product flow monitoring can thus be advantageously automated at least to a large extent, preferably completely. An efficiency of product flows can be advantageously increased. Advantageously, a misdirection of products can be avoided as far as possible. A high level of user-friendliness can be advantageously achieved, in particular by being able to make manual work steps, which in particular can represent sources of error, superfluous. The order of steps of the method according to the invention need not correspond to the order in which the features are mentioned in the claims, but may also deviate from the order in which the features are mentioned and/or may comprise additional steps or intermediate steps.

For example, product flows can comprise the routes of products/goods from the manufacturer to the end user or between manufacturers, suppliers, dealers and within a company. Preferably, the method according to the invention is configured at least for monitoring product flows within a warehouse and from a warehouse to the outside, as well as from the outside into the warehouse. The products may be, for example, embodied as packages (dimensioned with standardization, without standardization or randomly), pallets or the like. In particular, the product receiving unit is configured for accommodating a plurality or multiplicity of similar or different products. In particular, the storage space of the product receiving unit can receive a plurality or multiplicity of similar or different products at the same time. In particular, the product receiving unit is mobile or can be connected to a mobile towing vehicle or can be loaded onto the mobile towing vehicle. In particular, the product receiving unit is configured only for accommodating the products for the period in which the products are transported between different locations and/or transporting the products between the different locations. The conveyor device is preferably embodied as a floor conveyor device, such as a (fork)lift truck, a pallet truck, a tractor or the like. Alternatively, however, the conveyor device could also be embodied as an overhead conveyor device, such as an overhead track, a rail conveyor system or the like. In particular, the conveyor device is designed to be driverless or to be guided at least partially by an operator.

The product tag may, for example, be realized as an RFID tag, an optoelectronic code, such as a barcode, a data matrix code, a QR code or the like, or another tag that can be read out in the immediate vicinity by a reader. In particular, the product tag is attached, e.g. stuck or affixed, to the product. In particular, the reader is moved, by the movement of the conveyor device when picking up the product, into a readout region for the product tag, within which the reader of the conveyor device is able to read out the product tag. The readout region depends on the product tag and the reader, but is usually not more than 2 m, preferably not more than 1 m, preferably not more than 0.5 m and particularly preferably not more than 0.25 m. In particular, the reader is mounted on the conveyor device. In particular, the reader constantly or repeatedly monitors a loading region of the conveyor device, in which the products are located in the case of a loaded conveyor device. In particular, the pick-up of the product is positively detected as soon as the product tag is in the readout region of the reader. In particular, the reader is designed differently from a handheld scanner. In particular, the reader is functional and/or operable independently of an operator intervention. Alternatively, however, provision may also be made for the operator of the conveyor device to activate the reader as soon as he has picked up a product with the conveyor device. Preferably, the loading state of the product on the conveyor device is also monitored automatically/autonomously.

In particular, a geofence region should be understood as meaning an (a really closed) region whose boundary is invisible to a human eye and/or whose boundary is merely predefined by a digital boundary in a digital space. In particular, the geofence region surrounds the product receiving unit, preferably at least one region of a loading opening of the product receiving unit. In particular, the conveyor device tag and the product receiving unit tag communicate with each other or with a common central or decentralized system for determining the geofence region and/or determining when a boundary delimiting the geofence region is inwardly and/or outwardly transgressed. In particular, the conveyor device tag is permanently mounted on the conveyor device. Alternatively, the conveyor device tag could also be assigned to an operator of the conveyor device. The product receiving unit tag is in particular permanently fastened to the product receiving unit, for example centrally above the loading opening. The ability to no longer read out the product tag occurs in particular when the product tag has been removed from the readout region of the reader of the conveyor device, for example after the conveyor device has unloaded the product with the product tag and moves away from the product receiving unit. The confirmation that the conveyor device has left the loading zone, which is obtained in a manner closely related in time with when it is no longer possible to read out the tag, advantageously makes it possible to determine with very high certainty that the conveyor device has also actually loaded the product into the product receiving unit. In addition, it could be possible to provide a further reader which is assigned to the product receiving unit and reads, from the corresponding product tags, which products are currently located in the product receiving unit.

In a further aspect of the invention which can be considered on its own, or in combination with at least one, in particular in combination with one, in particular in combination with any number of the other aspects of the invention, it is proposed that at least the following steps are carried out in order to detect a completed unloading process:
detecting an availability of a loading area of the conveyor device by a lack of a readable product tag in a readout region of a reader assigned to the conveyor device, in particular by virtue of not being able to read out a product tag by means of the reader assigned to the conveyor device,
detecting when the conveyor device enters a loading zone of the product receiving unit by capturing when a geofence region delimiting the loading zone is transcended, in particular to within the geofence region, by means of a conveyor device tag assigned to the conveyor device and/or by means of a product receiving unit tag assigned to the product receiving unit,
detecting when a product is picked up by the conveyor device by reading out the product tag assigned to the product by means of the reader assigned to the conveyor device,
detecting when the conveyor device transporting the product leaves the loading zone by capturing when the geofence region delimiting the loading zone is transcended, in particular to outside the geofence region, by means of the conveyor device tag assigned to the conveyor device and/or by means of the product receiving unit tag assigned to the product receiving unit. As a result, monitoring of product flows can be advantageously improved, in particular made more reliable and/or safer, in particular by being able to reliably detect when a product, in particular an identified product, is unloaded.

If the conveyor device tag, in particular of the conveyor device, and the product receiving unit tag, in particular of the product receiving unit, communicate with each other using an ultra-wideband (UWB) radio technology, in particular at least during loading and/or unloading, and preferably at least immediately before loading and/or unloading and/or immediately after loading and/or unloading, it possible to advantageously obtain a method that is particularly accurate and/or reliable and/or insensitive to external influences, such as pollution, for setting up and monitoring a geofence, in particular the geofence region. Ultra-wideband radio technology is advantageously able to determine distance and/or direction in a particularly precise manner. In particular, the conveyor device tag and/or the product receiving unit tag comprise(s) a UWB transceiver. In particular, the UWB transceiver is realized as a sensor emitting and receiving electromagnetic waves, in particular wave packets, wherein the emitted electromagnetic waves, in particular the emitted wave packets, and the received electromagnetic waves, in particular the received wave packets, cover a particularly large bandwidth, preferably a bandwidth of more than 500 MHz. In particular, the wave packets emitted and received by the UWB transceiver comprise a multiplicity of electromagnetic waves of different frequency, which preferably have a fixed phase relationship to each other. In particular, the UWB transceiver detects the electromagnetic waves (ultra-wideband signals), in particular wave packets, emitted by the opposing conveyor device tag and/or the product receiving unit tag, in order to evaluate a position and/or distance of the opposing conveyor device tag and/or product receiving unit tag relative to the conveyor device tag and/or the product receiving unit tag. The distance is determined in particular by measuring the propagation time of a UWB signal which is exchanged (back and forth) between in each case two involved conveyor device tags and/or product receiving unit tags. A direction can be detected by each of the conveyor device tags and/or the product receiving unit tags having a plurality of antennas at a distance from each other and evaluating a time delay of the arrival of a UWB signal between two or more of these antennas. Preferably, a transmitter and/or a receiver of the UWB transceiver are/is operated continuously. Alternatively, however, it is also conceivable for the transmitter and/or the receiver of the UWB transceiver to be operated intermittently and/or in pulsed fashion. Advantageously, an influence and/or interference of other radio transmission methods, in particular other narrowband radio transmission methods, such as LoRa, 5G or WLAN (in particular 802.11p), can be prevented by using ultra-wideband sensor technology. In particular, the receiver of the UWB transceiver is configured for registering and processing a multiplicity of, in particular simultaneously received, ultra-wideband signals from different multifunction tags. It is conceivable for an identifier signal, which is integrated in the ultra-wideband signal or separate and allows the respective individual conveyor device tag and/or product receiving unit tag sending the identifier signal to be identified by other opposing conveyor device tags and/or product receiving unit tags, to also be transmitted with the ultra-wideband signal. In particular, it is conceivable for the conveyor device tag or the product receiving unit tag to be realized as a multi-function tag, as described in a German patent application with the application number 10 2021 118 998.5, the disclosure of which is intended to be incorporated in full in this patent application by this reference.

In addition, if ultra-wideband radio technology is used at least to determine a relative position between the conveyor device and the product receiving unit, such that in particular the geofence region is monitored, particularly accurate and/or reliable geofence monitoring can be advantageously enabled. This can advantageously exclude sources of error, such as a misidentification caused by an adjacent loading or unloading process. In addition, it is conceivable for the product receiving unit tag, in particular by means of ultra-wideband radio technology and via communication with anchor stations permanently installed in the warehouse, to be able to be configured for determining a position of the associated product receiving unit within the warehouse and preferably transmitting it to an external system, in particular relative to the product receiving unit and/or the conveyor device and/or the carrier vehicle, such as an enterprise resource-planning system. The term “configured” is in particular to mean specially programmed, designed and/or equipped. The fact that an object is configured for a particular function is in particular to mean that the object performs and/or carries out this particular function in at least one application and/or operating state.

It is also proposed that, when the product tag is read out by the reader of the conveyor device, the product is bijectively identified and, in particular, at least one item of product information relating to the product is read out. As a result, monitoring of product flows can be advantageously improved, in particular made more reliable and/or safer, in particular by being able to reliably detect when a product, in particular an identified product, is loaded. In particular, the product tag comprises at least one code which can be read out directly from the product tag or which is also transmitted to the reader when the product tag is read out and which comprises the product information and/or a unique product ID. For example, the product information may include a description of the product, a destination of the product, a quantity of the product or the like.

Furthermore, it is proposed that, at least during the loading process, the product information relating to the loaded product, as identified by the reader, and/or a product ID of the loaded product, as identified by the reader, are/is transmitted to the product receiving unit and/or to an external system, in particular relative to the product receiving unit and/or the conveyor device and/or the carrier vehicle, such as an enterprise resource-planning system, using the ultra-wideband radio technology or via a further interface, in particular of the conveyor device tag or of a radio unit connected to the conveyor device tag, that uses a radio technology that differs from the ultra-wideband radio technology. As a result, monitoring of product flows, in particular outgoing product flows, can be advantageously improved, in particular made more reliable and/or safer. In particular, a particularly comprehensive and particularly up-to-date data record of the products in a warehouse or a company can be obtained. The further radio technology of the conveyor device tag or the radio unit can be based, for example, on a known radio protocol such as WLAN, Bluetooth or the like.

Furthermore, if, at least during the unloading process, an item of product information relating to the unloaded product, which is stored by the product receiving unit, and/or a product ID of the unloaded product are/is transmitted to the conveyor device and/or to an external system, in particular relative to the product receiving unit and/or the conveyor device and/or the carrier vehicle, such as an enterprise resource-planning system, using ultra-wideband radio technology or via a further interface, in particular of the product receiving unit tag or of a further radio unit connected to the product receiving unit tag, that uses a radio technology that differs from ultra-wideband radio technology, monitoring of product flows, in particular incoming product flows, can be advantageously improved, in particular made more reliable and/or safer. In particular, a particularly comprehensive and particularly up-to-date data record of the products in a warehouse or a company can be obtained. The further radio technology of the product receiving unit tag or the further radio unit can be based, for example, on a known radio protocol such as WLAN, Bluetooth or the like.

Furthermore, it is proposed that the process of loading the product receiving unit by means of the conveyor device and/or a process of unloading the product receiving unit by means of the conveyor device is distinguished from the conveyor device, or in particular a further conveyor device, passing the product receiving unit by recognizing an orientation of the conveyor device relative to the product receiving unit by means of the ultra-wideband radio technology. This can advantageously enable particularly accurate and/or reliable product flow monitoring. This can advantageously exclude sources of error, such as a misidentification caused by a conveyor device only passing close to a product receiving unit. In order to distinguish the process of loading the product receiving unit by means of the conveyor device and/or a process of unloading the product receiving unit by means of the conveyor device from the conveyor device passing, it is possible to use the extent to which the conveyor device has rotated as a whole in the geofence region or in the immediate vicinity of the geofence region. A rotation of more than 80° within the geofence region or in the immediate vicinity of the geofence region (and outside all further geofence regions of the warehouse) can be used as a positive indicator of the loading or unloading process. A rotation of less than 80° within the geofence region or in the immediate vicinity of the geofence region (and outside all further geofence regions of the warehouse) can be used as a negative indicator of the loading or unloading process. Thus, if a rotation of more than 80°, in particular at least 90°, of the conveyor device is determined by the ultra-wideband radio technology, the residence of the conveyor device in the geofence region is registered as a loading process or as an unloading process. Thus, if a rotation of less than 80°, in particular less than 90°, of the conveyor device is determined by the ultra-wideband radio technology, the residence of the conveyor device in the geofence region is not registered as a loading process and is not registered as an unloading process.

In addition, it is proposed that the product receiving unit is realized as a laterally loadable transport container, in particular as a swap body. This can advantageously improve the organization of a warehouse which is served by large transport containers. Swap bodies can be advantageously organized optimally, in particular loaded and/or unloaded. As an alternative to the swap body, the laterally loadable transport container could also be embodied as a semi-trailer with sliding tarpaulin or with a laterally openable flap or the like. As an alternative to the swap body, the laterally loadable transport container could also be formed only by an open loading area, e.g. of a truck.

In addition, it is proposed that the reader of the conveyor device is realized as an RFID reader or an optical scanner, such as a 1D code scanner, a 2D code scanner, or a camera. This advantageously makes it possible to ensure an implementation of the product tag that is cost-effective, scalable and can be easily placed on the product.

It is further proposed that, in particular after completion of the loading process or of the unloading process, a connection of the product receiving unit to a carrier vehicle, for example a semitrailer tractor, is detected by virtue of a communication between the product receiving unit tag and a carrier vehicle tag, in particular using an ultra-wideband radio technology. As a result, monitoring of product flows can be advantageously improved, in particular made more reliable and/or safer, and can be extended, in particular, beyond a warehouse. In particular, it is conceivable for the carrier vehicle tag to be realized as a multi-function tag, as described in the German patent application with the application number 10 2021 118 998.5. In particular, the conveyor device tag, the product receiving unit tag and/or the carrier vehicle tag may be at least substantially identical to each other. In particular, ultra-wideband radio technology is used at least to determine a relative position between the carrier vehicle and the product receiving unit. The carrier vehicle tag can be permanently installed in the carrier vehicle or assigned to the driver of the carrier vehicle, e.g. when entering the warehouse. In particular, the carrier vehicle tag and/or the product receiving unit tag detect(s) the connection between the product receiving unit and the carrier vehicle by virtue of a maximum distance between the two tags being undershot. For this purpose, the positions of the two tags in the carrier vehicle and in the product receiving unit must be known in particular as precisely as possible. Alternatively, the connection between the product receiving unit and the carrier vehicle could be detected by capturing a common relative movement to fixed known points, e.g. UWB anchor stations or distinctive spatial features.

If a product ID of the product currently present in the product receiving unit, as stored by the product receiving unit, and/or at least one item of product information relating to the product currently present in the product receiving unit are/is transmitted from the product receiving unit, in particular from the product receiving unit tag, to the carrier vehicle, in particular the carrier vehicle tag, in particular using the ultra-wideband radio technology or a further radio technology, for example WLAN, Bluetooth or the like, or using a separate radio protocol in a frequency range intended for this, it is possible to advantageously ensure particularly complete product flow monitoring. It is highly probable that incorrect deliveries can be advantageously excluded. In particular, each time the content of the product receiving unit is changed, for example as a result of loading or unloading, an updated overview is transmitted from the product receiving unit tag to the carrier vehicle tag.

In addition, it is proposed that, when the conveyor device transporting the product enters the loading zone, a product receiving unit ID, which bijectively identifies the product receiving unit, is transmitted to the conveyor device, whereupon an internal or external database is queried by the conveyor device in order to check whether the product, in particular the product previously identified by means of the reader of the conveyor device, is intended to be loaded into the product receiving unit with this product receiving unit ID. It is highly probable that incorrect deliveries can be advantageously excluded as a result. For example, the external database may be provided by the enterprise resource-planning system. The external database can be queried by the conveyor device, for example, using ultra-wideband radio technology or by means of a further interface, in particular of the conveyor device tag or of a radio unit connected to the conveyor device tag, that uses a radio technology that differs from ultra-wideband radio technology.

Also proposed are an apparatus for carrying out the above-described method, comprising at least one reader and at least one conveyor device tag, each for mounting on a conveyor device, and comprising at least one product receiving unit tag for mounting on a product receiving unit, and a system with the apparatus, with at least one conveyor device and with at least one product receiving unit, in particular a swap body. As a result, monitoring of product flows can be advantageously improved, in particular made more reliable and/or safer, in particular by being able to reliably detect when a product, in particular an identified product, is loaded. The product flow monitoring can thus be advantageously automated at least to a large extent, preferably completely. An efficiency of product flows can be advantageously increased. Advantageously, a misdirection of products can be avoided as far as possible.

The method according to the invention, the apparatus according to the invention and the system according to the invention are not intended to be limited here to the above-described application and embodiment. In particular, the method according to the invention, the apparatus according to the invention and the system according to the invention may have a number of individual method steps, elements, components and units deviating from a number mentioned herein in order to comply with a method of operation described herein.

### DRAWINGS

Further advantages emerge from the following description of the drawings. The drawings illustrate an exemplary embodiment of the invention. The drawings, the description and the claims contain numerous features in combination. A person skilled in the art will also expediently consider the features individually and combine them into useful further combinations.

In the Drawings:

FIG. 1 schematically shows a warehouse with a system comprising an apparatus for carrying out a method for monitoring product flows,

FIG. 2 schematically shows a part of the system comprising a conveyor device, a product receiving unit and a carrier vehicle,

FIG. 3 schematically shows the conveyor device and the product receiving unit with a part of the apparatus,

FIG. 4 schematically shows the carrier vehicle and the product receiving unit with a further part of the apparatus, and

FIG. 5 shows a schematic flowchart of the method for monitoring product flows within the warehouse.

### DESCRIPTION OF THE EXEMPLARY EMBODIMENT

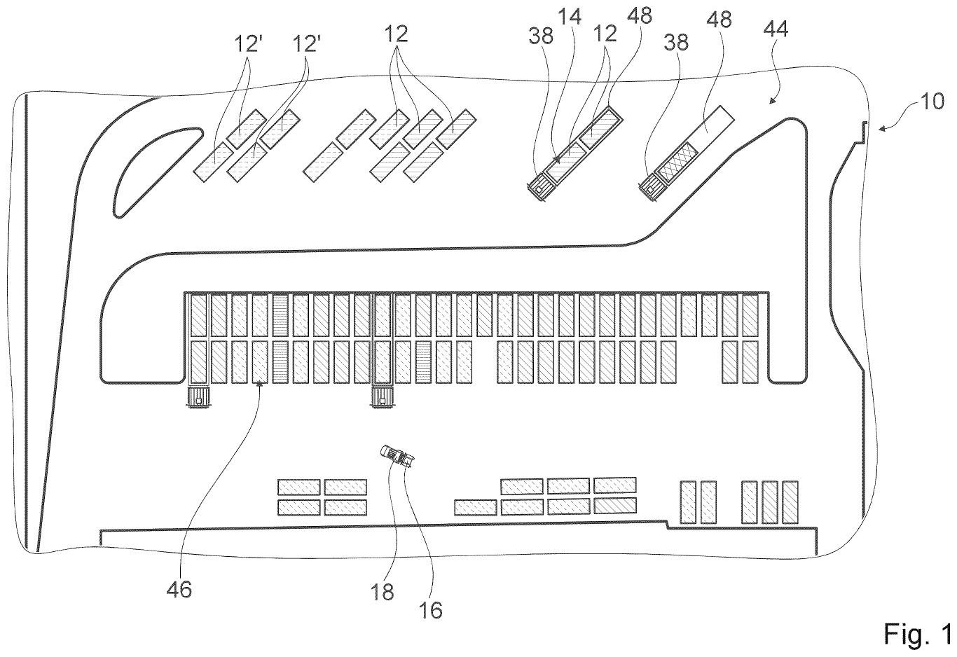

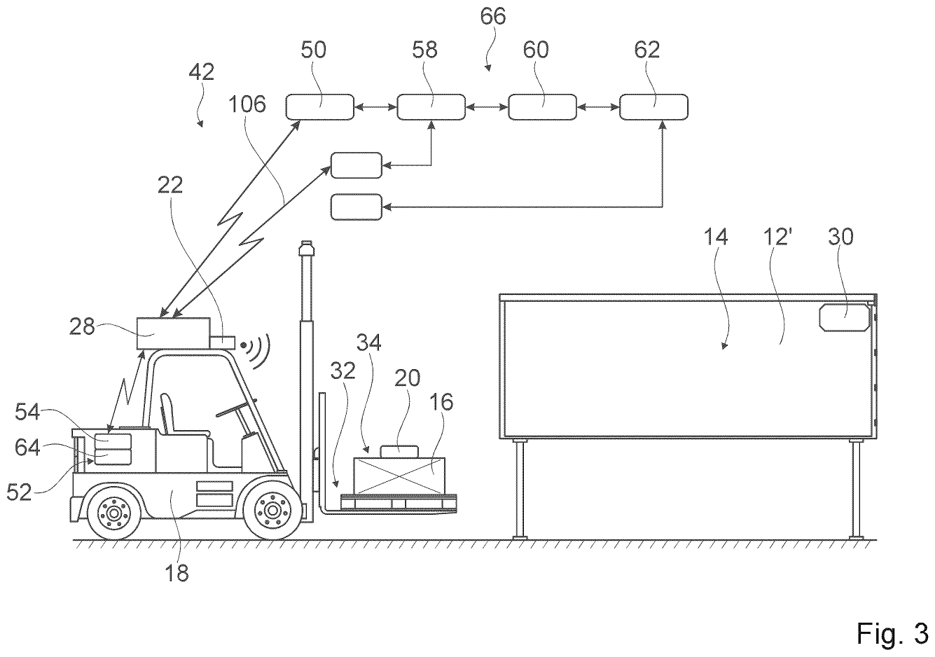

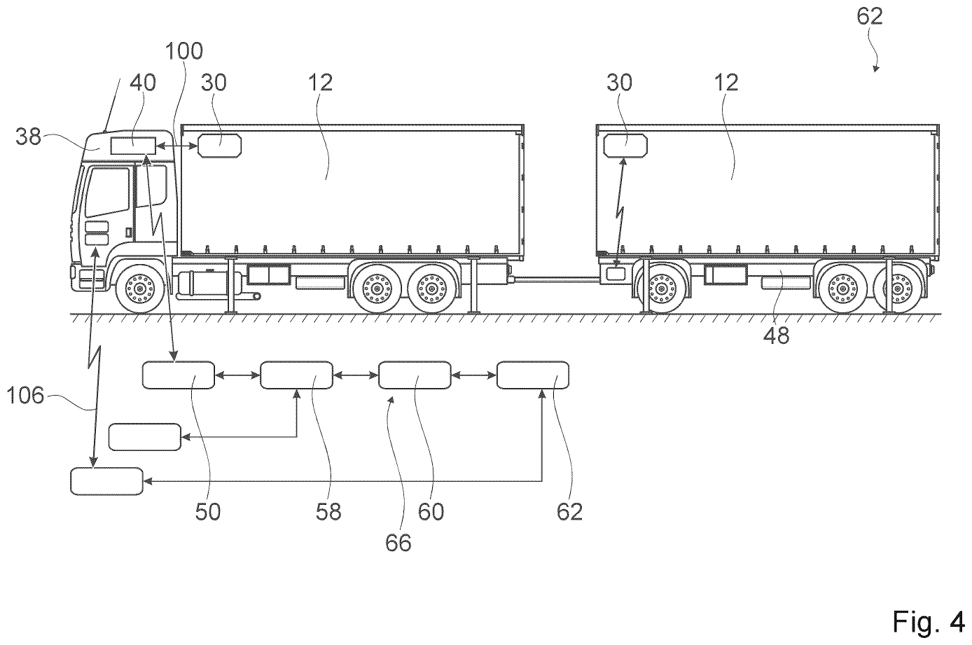

FIG. 1 schematically shows a warehouse 10. The warehouse 10 comprises storage locations 46 for products 16 which are delivered to the warehouse 10 and/or are shipped from the warehouse 10. The warehouse 10 comprises a system 44 for organizing the delivery and shipping. The system 44 comprises a conveyor device 18 (cf. also FIG. 3). The conveyor device 18 is embodied as a floor conveyor device. The conveyor device 18 is embodied as a forklift truck. The system 44 comprises product receiving units 12. The product receiving units 12 each provide a storage space 14 for a temporary accommodation of the products 16. The product receiving units 12 are configured for storage of the products 16 during transport of the products 16 between two locations. The product receiving units 12 form transport containers for the products 16. In the exemplary embodiment shown in the figures, the product receiving units 12 are realized as swap bodies. Alternatively or additionally, the product receiving units 12 or individual product receiving units 12 may also be realized as different laterally loadable transport containers, such as semi-trailers with sliding tarpaulin or the like. The conveyor device 18 can be moved within the warehouse 10. The conveyor device 18 is configured for transporting the products 16 within the warehouse 10. The conveyor device 18 is configured to carry out a process of loading the products 16 into the product receiving unit 12. The conveyor device 18 is configured to carry out a process of unloading the products 16 from the product receiving unit 12. In the warehouse 10, empty product receiving units 12′ and full product receiving units 12 are set up and are loaded and/or unloaded by the conveyor device 18. The product receiving units 12, which are realized as swap bodies, are delivered and/or collected by carrier vehicles 38. The swap bodies can be separated from the carrier vehicles 38 and parked. The swap bodies can be loaded onto the carrier vehicles 38 or onto trailers 48 of the carrier vehicles 38 and carried with the carrier vehicles 38. The carrier vehicles 38 may be embodied as semitrailer tractors (cf. also FIG. 4).

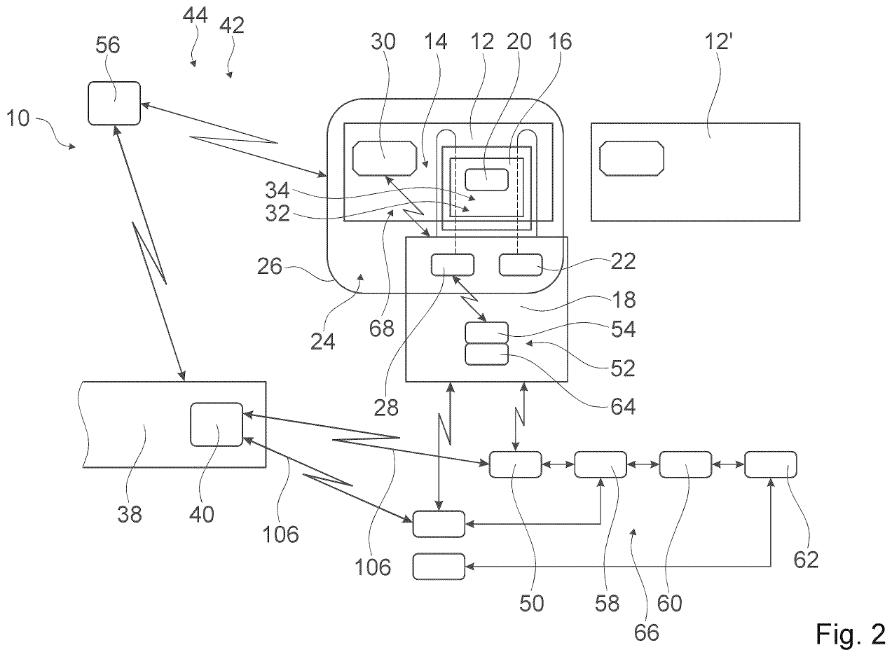

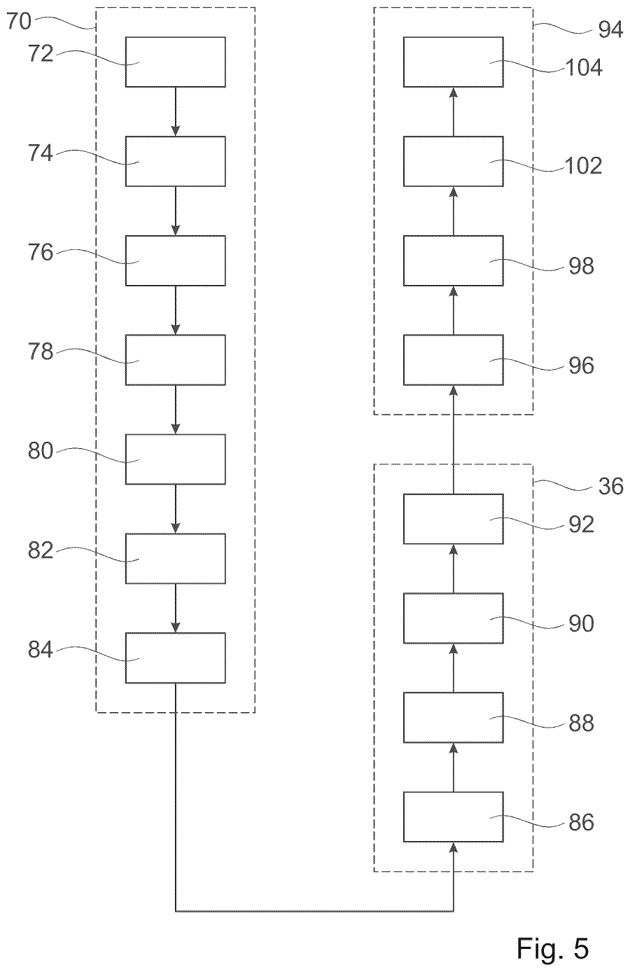

FIG. 2 schematically shows at least a part of the system 44. The system 44 has an apparatus 42. The apparatus 42 is configured to carry out the method shown in FIG. 5. The apparatus 42 comprises a product tag 20. The product tag 20 is assigned to the product 16. A separate product tag 20 is respectively assigned to each product unit (e.g. each Euro pallet) in the warehouse 10. For example, the product tag 20 is realized as an RFID chip. The apparatus 42 has a reader 22. The reader 22 is assigned to the conveyor device 18. The reader 22 is permanently installed in the conveyor device 18. The reader 22 is configured for reading out the product tag 20 when it is located in a readout region 34 of the reader 22. The reader 22 is configured for reading out the product tag 20 when it is located in a loading area 32 of the conveyor device 18. The readout region 34 of the reader 22 (completely) overlaps the loading area 32 of the conveyor device 18. The reader 22 is mounted on the conveyor device 18 in such a way that it has/can monitor the loading area 32 of the conveyor device 18 in its field of view. The reader 22 is, for example, realized as an RFID reader. The reader 22 is configured for monitoring a loading state of the product 16 on the conveyor device 18 by repeated or continuous reading out of the product tag 20 assigned to the product 16. The reader 22 is configured for bijectively identifying the product 16 by reading out the product tag 20. The reader 22 is configured for reading out at least one item of product information relating to the product 16 by reading out the product tag 20.

The apparatus 42 comprises a conveyor device tag 28. The conveyor device tag 28 is assigned to the conveyor device 18. A separate conveyor device tag 28 is assigned to each conveyor device 18. The conveyor device tag 28 is designed for mounting on the conveyor device 18. The conveyor device tag 28 is permanently mounted on the conveyor device 18. The conveyor device tag 28 is configured to communicate using ultra-wideband radio technology. The conveyor device tag 28 is configured for monitoring an environment of the conveyor device 18 using ultra-wideband technology. The conveyor device tag 28 is configured for detecting and/or communicating with other tags of the apparatus 42 that communicate using ultra-wideband radio technology. The conveyor device tag 28 may moreover also be configured for ultra-wideband communication with anchor stations 50 permanently installed in the warehouse 10, in particular for locating the conveyor device 18 within the warehouse 10. Alternatively or additionally, the conveyor device tag 28 can moreover also be configured for mobile radio communication (e.g. LTE or 5G) with the anchor stations 50 permanently installed in the warehouse 10 or with a backend 58. The warehouse 10 comprises a product flow control system 66 with a backend 58, an interface database 60, and an enterprise resource-planning system 62. The conveyor device tag 28 can be configured for direct communication with the product flow control system 66 via a mobile radio connection (e.g. LTE or 5G) or for indirect communication with the product flow control system 66 via UWB data exchange with the anchor station 50. Alternatively or additionally, the conveyor device tag 28 may moreover also be configured for receiving signals from a satellite navigation system 56. The conveyor device 18 has a control device 52 with a frontend 54 and an interface (GUI) 64. The conveyor device tag 28 transmits data to the frontend 54 for display to a user via the interface 64. The conveyor device tag 28 transmits data to the product flow control system 66. These data may respectively comprise position data relating to the conveyor device 18, data relating to interactions with other tags of the apparatus 42, or data relating to entry or exit into/out of a geofence region 26. The reader 22 can also communicate data to the frontend 54 for display to a user via the interface 64. These data can be product information, product IDs or transport information/specifications for transporting the products 16.

The apparatus 42 has a product receiving unit tag 30. The product receiving unit tag 30 is assigned to the product receiving unit 12. Each product receiving unit 12 in the warehouse 10 is assigned a separate product receiving unit tag 30. The product receiving unit tag 30 is designed for mounting on the product receiving unit 12. The product receiving unit tag 30 is permanently mounted on the product receiving unit 12. The product receiving unit tag 30 is configured to communicate using ultra-wideband radio technology. The product receiving unit tag 30 is configured for monitoring an environment of the product receiving unit 12 using ultra-wideband technology. The product receiving unit tag 30 is configured for detecting and/or for communicating with other tags of the apparatus 42, for example the conveyor device tag 28, that communicate using ultra-wideband radio technology. The product receiving unit tag 30 may moreover also be configured for ultra-wideband communication with the anchor stations 50 permanently installed in the warehouse 10, in particular for locating the product receiving unit 12 within the warehouse 10. The product receiving unit tag 30 can be configured for direct communication with the product flow control system 66 via a mobile radio connection (e.g. LTE or 5G) or for indirect communication with the product flow control system 66 via UWB data exchange with the anchor station 50. Alternatively or additionally, the product receiving unit tag 30 may moreover also be configured for alternative radio communication 106 (e.g. IEEE 802.15.4) with the anchor stations 50 permanently installed in the warehouse 10. Alternatively or additionally, the product receiving unit tag 30 may moreover also be configured for receiving signals from the satellite navigation system 56. The product receiving unit tag 30 transmits data to the product flow control system 66. These data may comprise position data relating to the product receiving unit 12, data relating to interactions with other tags of the apparatus 42, a loading level of products 16 loaded in the product receiving unit 12, or data relating to entry or exit of other tags into/out of the geofence region 26 of the product receiving unit tag 30.

The product receiving unit tag 30 is configured for defining the geofence region 26. The product receiving unit tag 30 is configured for monitoring the geofence region 26. The product receiving unit tag 30 is configured for transmitting the geofence region 26 to further tags of the apparatus 42, for example to the conveyor device tag 28. The geofence region 26 forms a loading zone 24 of the product receiving unit 12 with the product receiving unit tag 30. The geofence region 26 surrounds at least one (lateral) loading opening 68 of the product receiving unit 12. The geofence region 26 does not extend or extends only negligibly beyond a longitudinal extent of the product receiving unit 12. For example, the geofence region 26 may be restricted to all points that are at a distance of less than 2 m, preferably less than 1.5 mm, and preferably less than 1 m, from the loading opening 68 of the product receiving unit 12.

The apparatus 42 has a carrier vehicle tag 40. The carrier vehicle tag 40 is assigned to the carrier vehicle 38. Each carrier vehicle 38 in the warehouse 10 is assigned a separate carrier vehicle tag 40. The carrier vehicle tag 40 is intended for mounting on the carrier vehicle 38. The carrier vehicle tag 40 is permanently mounted on the carrier vehicle 38. Alternatively, the carrier vehicle tag 40 may also be implemented as a mobile device which is assigned to a driver of the carrier vehicle 38 and which must be carried during movements of the carrier vehicle 38. The carrier vehicle tag 40 is configured to communicate using ultra-wideband radio technology. The carrier vehicle tag 40 is configured for monitoring an environment of the product receiving unit 12 using ultra-wideband technology. The carrier vehicle tag 40 is configured for detecting and/or communicating with other tags of the apparatus 42, for example the product receiving unit tag 30, that communicate using ultra-wideband radio technology. The carrier vehicle tag 40 is configured for detecting a connection between the product receiving unit 12 and the carrier vehicle 38 by communicating the product receiving unit tag 30 with a carrier vehicle tag 40 using ultra-wideband radio technology. The product receiving unit tag 30 is configured for transmitting the product ID(s) of the product(s) 16 currently present in the product receiving unit 12, which are stored by the product receiving unit 12 and are received from the conveyor vehicle tag 28, to the carrier vehicle tag 40 using ultra-wideband radio technology. The product receiving unit tag 30 is configured for transmitting the item(s) of product information relating to the product(s) 16 currently present in the product receiving unit 12, which is/are stored by the product receiving unit 12 and is/are received from the conveyor vehicle tag 28, to the carrier vehicle tag 40 using ultra-wideband radio technology. The carrier vehicle tag 40 may be configured for outputting, to a driver of the carrier vehicle 38, information about which product receiving units 12 are to be approached and/or where certain product receiving units 12 are to be delivered to.

The carrier vehicle tag 40 may moreover also be configured for ultra-wideband communication with the anchor stations 50 permanently installed in the warehouse 10, in particular for locating the carrier vehicle 38 within the warehouse 10. Alternatively or additionally, the carrier vehicle tag 40 may moreover also be configured for alternative radio communication 106 (e.g. IEEE 802.15.4) with the anchor stations 50 permanently installed in the warehouse 10. The carrier vehicle tag 40 can be configured for direct communication with the product flow control system 66 via a mobile radio connection (e.g. LTE or 5G) or for indirect communication with the product flow control system 66 via UWB data exchange with the anchor station 50. Alternatively or additionally, the carrier vehicle tag 40 may moreover also be configured for receiving signals from the satellite navigation system 56. The carrier vehicle tag 40 transmits data to the product flow control system 66. These data may comprise position data relating to the carrier vehicle 38 or data relating to interactions with other tags of the apparatus 42.

FIG. 5 shows a schematic flowchart of a method for monitoring product flows within the warehouse 10. The method comprises a first method part 70 in which a sequence of method steps 72, 74, 76, 78, 80, 82, 84 are carried out in order to detect a completed loading process. In at least one method step 72, it is detected when the product 16 is picked up by the conveyor device 18. It is detected when the product 16 is picked up by the conveyor device 18 by reading out the product tag 20 assigned to the product 16 by means of the reader 22 assigned to the conveyor device 18. In method step 72, the product 16 is bijectively identified when the product tag 20 is read out by the reader 22. In method step 72, product information relating to the product 16 is read out when the product tag 20 is read out by the reader 22. In at least one further method step 74, the product information relating to the product 16 to be loaded, as identified by the reader 22, and/or the product ID of the product 16 to be loaded, as identified by the reader 22, are/is transmitted to the product receiving unit 12 and/or to the enterprise resource-planning system 62 using ultra-wideband radio technology or via a further interface using a radio technology that differs from ultra-wideband radio technology. In at least one further method step 76, information about where an operator of the conveyor device 18 is supposed to bring the product 16, in particular into which product receiving unit 12 the operator is supposed to load the product 16, is displayed to said operator via the interface 64 of the conveyor device 18.

In at least one further method step 78, the loading state of the product 16 on the conveyor device 18 is monitored by repeated or continuous reading out of the product tag 20 assigned to the product 16 by means of the reader 22. In at least one further method step 80, as the conveyor device 18 approaches a product receiving unit 12 in the warehouse 10, a check is carried out, by means of communication between the product receiving unit tag 30 and the conveyor device tag 28, in order to determine whether the product receiving unit 12 corresponds to the product receiving unit 12 into which the product 16 identified and currently being loaded by the conveyor device 18 is intended to be loaded. The conveyor device tag 28 and the product receiving unit tag 30 communicate with each other using ultra-wideband radio technology. In addition, it is checked, for example, whether the product tag 20, which is currently located in the readout region 34 of the reader 22, is part of a border of this product receiving unit 12. When the conveyor device 18 transporting the product 16 enters the loading zone 24, a product receiving unit ID, which bijectively identifies the product receiving unit 12, is transmitted in this method step 80 to the conveyor device 18, whereupon an internal or external database is queried by the conveyor device 18 in order to check whether the product 16 previously identified by means of the reader 22 is intended to be loaded into precisely this product receiving unit 12 with the received product receiving unit ID.

In at least one further method step 82, it is detected when the conveyor device 18 transporting the product 16 enters the loading zone 24 of the product receiving unit 12 by capturing when the geofence region 26 delimiting the loading zone 24 is transcended by means of the conveyor device tag 28 assigned to the conveyor device 18 and by means of the product receiving unit tag 30 assigned to the product receiving unit 12. For monitoring the geofence region 26, ultra-wideband radio technology is used to determine a relative position between the conveyor device 18 and the product receiving unit 12. In at least one further method step 84, it is detected when the product 16 is deposited by the conveyor device 18. The deposit of the product 16 is determined by detecting when the product 16 leaves the loading area 32 of the conveyor device 18. Leaving the loading area 32 of the conveyor device 18 is detected by virtue of no longer being able to read out the product tag 20 assigned to the product 16 by means of the reader 22. In addition, in method step 84, the deposit of the product 16 is confirmed by detecting that the loading zone 24 is left by virtue of the conveyor device 18 no longer being able to read out the product tag 20. Leaving the loading zone 24 is detected by capturing when the geofence region 26 delimiting the loading zone 24 is transcended by means of the conveyor device tag 28 assigned to the conveyor device 18 and by means of the product receiving unit tag 30 assigned to the product receiving unit 12. The process of loading the product receiving unit 12 by means of the conveyor device 18 is distinguished from the conveyor device 18 passing the product receiving unit 12 by recognizing an orientation of the conveyor device 18 relative to the product receiving unit 12 and/or a change in the overall direction of the conveyor device 18 within the loading zone 24 by means of ultra-wideband radio technology.

The method comprises a second method part 36 in which a sequence of method steps 86, 88, 90, 92 are carried out in order to detect a completed unloading process. In at least one method step 86, an availability of the loading area 32 of the conveyor device 18 is detected by a lack of a readable product tag 20 in the readout region 34 of the reader 22 assigned to the conveyor device 18. In at least one further method step 88, it is detected when the conveyor device 18 enters the loading zone 24 of the product receiving unit 12 by capturing when the geofence region 26 delimiting the loading zone 24 is transcended by means of the conveyor device tag 28 assigned to the conveyor device 18 and/or by means of the product receiving unit tag 30 assigned to the product receiving unit 12.

In at least one further method step 90, it is detected when a product 16 previously stored in the product receiving unit 12 is picked up by the conveyor device 18 by reading out/being able to read out the product tag 20 assigned to the product 16 by means of the reader 22. When the product tag 20 is read out by the reader 22, the product 16 is bijectively identified and product information relating to the product 16 is read out. In the unloading process, the product information relating to the unloaded product 16, which is stored by the product receiving unit 12 and is read out, and/or a product ID of the unloaded product 16 are/is transmitted to the conveyor device 18 and/or to the enterprise resource-planning system 62 using ultra-wideband radio technology or via a further interface using a radio technology that differs from ultra-wideband radio technology. In at least one further method step 92, it is detected when the conveyor device 18 transporting the product 16 leaves the loading zone 24 by capturing when the geofence region 26 delimiting the loading zone 24 is transcended by means of the conveyor device tag 28 assigned to the conveyor device 18 and by means of the product receiving unit tag 30 assigned to the product receiving unit 12. The process of unloading the product receiving unit 12 by means of the conveyor device 18 is distinguished from the conveyor device 18 passing the product receiving unit 12 by recognizing an orientation of the conveyor device 18 relative to the product receiving unit 12 and/or a change in the overall direction of the conveyor device 18 within the loading zone 24 by means of ultra-wideband radio technology.

The method comprises a third method part 94 in which, after completion of the loading process or of the unloading process, a connection of the product receiving unit 12 to a carrier vehicle 38 is detected by virtue of a communication between the product receiving unit tag 30 and the carrier vehicle tag 40 using ultra-wideband radio technology. In a method step 96, an approach of the carrier vehicle 38 to the product receiving unit 12 is monitored by means of ultra-wideband communication between the carrier vehicle tag 40 and the product receiving unit tag 28. Using ultra-wideband technology may advantageously enable particularly high accuracy of the distance measurement between the carrier vehicle tag 40 and the product receiving unit tag 28. In at least one further method step 98, it is detected when a predefined limit distance 100 (cf. also FIG. 4) between the carrier vehicle tag 40 and the product receiving unit tag 28 is undershot. Based on this undershooting of the limit distance 100, a pick-up of the product receiving unit 12 with the carrier vehicle 38/a connection of the carrier vehicle 38 to the product receiving unit 12 is confirmed. In at least one further method step 102, after confirmation of the connection in method step 98, the product ID of the product 16 currently present in the product receiving unit 12, as stored by the product receiving unit 12, and/or product information relating to the product 16 currently present in the product receiving unit 12 are/is transmitted from the product receiving unit 12 to the carrier vehicle 38 using ultra-wideband radio technology. The product receiving unit tag 30 has at least one digital storage medium for storing the product IDs and/or the product information. In at least one further method step 104, it is detected when the predefined limit distance 100 (cf. also FIG. 4) between the carrier vehicle tag 40 and the product receiving unit tag 28 is exceeded. Based on this exceeding of the limit distance 100, deposit of the product receiving unit 12 by the carrier vehicle 38/separation of the carrier vehicle 38 and the product receiving unit 12 is confirmed.

1. A method for monitoring product flows, in particular at least within a warehouse, with at least one product receiving unit, which provides a storage space for a temporary accommodation of products, and with at least one conveyor device, in particular a floor conveyor device, which is movable at least within the warehouse and is configured for transporting products at least within the warehouse and/or carrying out a process of loading products into the product receiving unit and/or a process of unloading products from the product receiving unit, wherein at least the following steps are carried out in order to detect a completed loading process:
detecting when a product is picked up by the conveyor device by reading out a product tag assigned to the product by means of a reader assigned to the conveyor device,
monitoring the loading state of the product on the conveyor device by repeated or continuous reading out of the product tag assigned to the product by means of the reader assigned to the conveyor device,
detecting when the conveyor device transporting the product enters a loading zone of the product receiving unit by capturing when a geofence region delimiting the loading zone is transcended by means of a conveyor device tag assigned to the conveyor device and/or by means of a product receiving unit tag assigned to the product receiving unit,
detecting when the product is deposited by the conveyor device by virtue of no longer being able to read out the product tag assigned to the product by means of the reader assigned to the conveyor device, and
detecting when the conveyor device no longer transporting the product leaves the loading zone by capturing when the geofence region delimiting the loading zone is transcended by means of the conveyor device tag assigned to the conveyor device and/or by means of the product receiving unit tag assigned to the product receiving unit.

2. The method as claimed in claim 1, wherein at least the following steps are carried out in order to detect a completed unloading process:
detecting an availability of a loading area of the conveyor device by a lack of a readable product tag in a readout region of a reader assigned to the conveyor device,
detecting when the conveyor device enters a loading zone of the product receiving unit by capturing when a geofence region delimiting the loading zone is transcended by means of a conveyor device tag assigned to the conveyor device and/or by means of a product receiving unit tag assigned to the product receiving unit,
detecting when a product is picked up by the conveyor device by reading out the product tag assigned to the product by means of the reader assigned to the conveyor device,
detecting when the conveyor device transporting the product leaves the loading zone by capturing when the geofence region delimiting the loading zone is transcended by means of the conveyor device tag assigned to the conveyor device and/or by means of the product receiving unit tag assigned to the product receiving unit

3. The method as claimed in claim 1, wherein the conveyor device tag and the product receiving unit tag communicate with each other via an ultra-wideband radio technology.

4. The method as claimed in claim 3, wherein the ultra-wideband radio technology is used at least to determine a relative position between the conveyor device and the product receiving unit, such that in particular the geofence region is monitored.

5. The method as claimed in claim 1, wherein when the product tag is read out by the reader of the conveyor device, the product is bijectively identified and, in particular, at least one item of product information relating to the product is read out.

6. The method as claimed in claim 5, wherein the conveyor device tag and the product receiving unit tag communicate with each other via an ultra-wideband radio technology, and wherein, at least during the loading process, the product information relating to the loaded product, as identified by the reader, and/or a product ID of the loaded product, as identified by the reader, are/is transmitted to the product receiving unit and/or to an external system, such as an enterprise resource-planning system, using ultra-wideband radio technology or via a further interface using a radio technology that differs from ultra-wideband radio technology.

7. The method as claimed in claim 2, wherein the conveyor device tag and the product receiving unit tag communicate with each other via an ultra-wideband radio technology, and wherein at least during the unloading process, an item of product information relating to the unloaded product, which is stored by the product receiving unit, and/or a product ID of the unloaded product are/is transmitted to the conveyor device and/or to an external system, such as an enterprise resource-planning system, using the ultra-wideband radio technology or via a further interface using a radio technology that differs from the ultra-wideband radio technology.

8. The method as claimed in claim 3, wherein the process of loading the product receiving unit by means of the conveyor device and/or a process of unloading the product receiving unit by means of the conveyor device is distinguished from the conveyor device passing the product receiving unit by recognizing an orientation of the conveyor device relative to the product receiving unit by means of the ultra-wideband radio technology.

9. The method as claimed in claim 1, wherein the product receiving unit is realized as a laterally loadable transport container, in particular as a swap body.

10. The method as claimed in claim 1, wherein the reader of the conveyor device is realized as an RFID reader or an optical scanner, such as a 1D code scanner, a 2D code scanner, or a camera.

11. The method as claimed in claim 1, wherein, in particular after completion of the loading process or of the unloading process, a connection of the product receiving unit to a carrier vehicle, for example a semitrailer tractor, is detected by virtue of a communication between the product receiving unit tag and a carrier vehicle tag in particular using an ultra-wideband radio technology.

12. The method as claimed in claim 11, wherein a product ID of the product currently present in the product receiving unit, as stored by the product receiving unit, and/or at least one item of product information relating to the product currently present in the product receiving unit are/is transmitted from the product receiving unit to the carrier vehicle in particular using ultra-wideband radio technology.

13. The method as claimed in claim 1, wherein when the conveyor device transporting the product enters the loading zone, a product receiving unit ID, which bijectively identifies the product receiving unit, is transmitted to the conveyor device whereupon an internal or external database is queried by the conveyor device in order to check whether the product, in particular the product previously identified by means of the reader of the conveyor device, is intended to be loaded into the product receiving unit with this product receiving unit ID.

14. An apparatus for carrying out a method as claimed in claim 1, comprising at least one reader and a conveyor device tag, each for mounting on a conveyor device, and comprising at least one product receiving unit tag for mounting on a product receiving unit.

15. A system with the apparatus as claimed in claim 14, with at least one conveyor device and with at least one product receiving unit, in particular a swap body.

16. A method for monitoring product flows, in particular at least within a warehouse, with at least one product receiving unit, which provides a storage space for a temporary accommodation of products, and with at least one conveyor device, in particular a floor conveyor device, which is movable at least within the warehouse and is configured for transporting products at least within the warehouse and/or carrying out a process of loading products into the product receiving unit and/or a process of unloading products from the product receiving unit, wherein at least the following steps are carried out in order to detect a completed unloading process:
detecting an availability of a loading area of the conveyor device by a lack of a readable product tag in a readout region of a reader assigned to the conveyor device,
detecting when the conveyor device enters a loading zone of the product receiving unit by capturing when a geofence region delimiting the loading zone is transcended by means of a conveyor device tag assigned to the conveyor device and/or by means of a product receiving unit tag assigned to the product receiving unit,
detecting when a product is picked up by the conveyor device by reading out the product tag assigned to the product by means of the reader assigned to the conveyor device, and
detecting when the conveyor device transporting the product leaves the loading zone by capturing when the geofence region delimiting the loading zone is transcended by means of the conveyor device tag assigned to the conveyor device and/or by means of the product receiving unit tag assigned to the product receiving unit.
